(19) United States
(12) Patent Application Publication
(10) Pub. No.: US 2023/0283567 A1
(43) Pub. Date: Sep. 7, 2023

(54) PROGRAMMING HIERARCHICAL SCHEDULERS FOR PORTS OF NETWORK DEVICES BASED ON HUMAN-READABLE CONFIGURATIONS

(71) Applicant: Arista Networks, Inc., Santa Clara, CA (US)

(72) Inventors: Prashant Kumar Kumar, Bangalore (IN); Shilpa Madhukar Naik, Karwar (IN); Mukund Pb, Bangalore (IN); Aditya Kumar, Bangalore (IN); Kevin Francis Francis Paulraj, Hayward, CA (US); Srinivas Prasad Prabhu, Saratoga, CA (US)

(21) Appl. No.: 17/685,904

(22) Filed: Mar. 3, 2022

(51) Int. Cl. H04L 47/62; H04L 47/6295; H04L 47/6275; H04L 47/625; H04L 49/90

(52) U.S. Cl. CPC H04L 47/623; H04L 47/6295; H04L 47/6275; H04L 47/627; H04L 49/90

(57) ABSTRACT

Embodiments of the present disclosure include techniques for programming hierarchical schedulers for ports of network devices. A configuration for configuring a hierarchy of a plurality of scheduling nodes of a packet scheduler is received. The packet scheduler is configured to schedule packets for egress out of a port of the network device. The configuration is specified in a human-readable format. Based on the configuration, the packet scheduler of the port is programmed. A plurality of packets are received at a plurality of physical queues communicatively coupled to the packet scheduler. The packet scheduler is used to select a packet in the plurality of packets from a physical queue in the plurality of physical queues. The selected packet is forwarded out the port of the network device.

### BACKGROUND

A network scheduler (also referred to as a packet scheduler), may be a component in a network switch in a packet-switched network. The network scheduler includes logic for determining which network packet to forward next. A queuing system that stores the network packets temporarily until they are transmitted can be associated with a network scheduler. Different network schedulers may implement any number of different network scheduling algorithms. Examples of such algorithms include first in, first out (FIFO), round robin, fair queuing, weighted fair queuing, etc.

The following detailed description and accompanying drawings provide a better understanding of the nature and advantages of various embodiments of the present disclosure.

### BRIEF DESCRIPTION OF THE DRAWINGS

FIG. 1 illustrates a network device according to some embodiments.

FIG. 2 illustrates a port according to some embodiments.

FIGS. 3A-3D illustrate a configuration for a port according to some embodiments.

FIG. 4 illustrates a process for configuring and using a scheduler of a port according to some embodiments.

FIG. 5 illustrates an example network device according to some embodiments.

### DETAILED DESCRIPTION

In the following description, for purposes of explanation, numerous examples and specific details are set forth in order to provide a thorough understanding of the present disclosure. It will be evident, however, to one skilled in the art that various embodiments of the present disclosure as defined by the claims may include some or all of the features in these examples alone or in combination with other features described below, and may further include modifications and equivalents of the features and concepts described herein.

Described herein are techniques for programming hierarchical schedulers for ports of network devices. In some embodiments, a network device includes any of different ports. Examples of such ports include network ports, processor ports, management ports, communication fabric ports, etc. Each of these ports of the network device may include a scheduler and several physical queues. When a port receives a piece of data (e.g., a packet), the piece of data is sent to one of the physical queues where it waits to be transmitted out of the port. The scheduler of a port can include a hierarchy of scheduling nodes that implement the logic for determining from which physical queue to transmit data. When a piece of data is to be transmitted out of the port, the scheduler of the port traverses the hierarchy of scheduling nodes to select a physical queue of the port and then transmits a piece of data in the selected physical queue out through the port. In some embodiments, a configuration for a hierarchy of scheduling nodes of a scheduler of a port may be specified using a human-readable n-ary tree format.

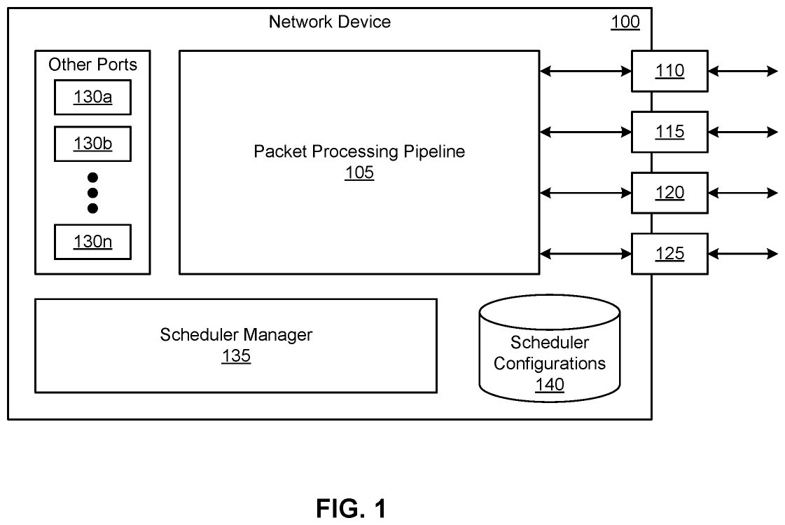

FIG. 1 illustrates a network device 100 according to some embodiments. As shown, network device 100 includes packet processing pipeline 105, network ports 110-125, other ports 130a-n, scheduler manager 135, and scheduler configurations storage 140. Scheduler configurations storage 140 is configured to store configurations for schedulers. In some embodiments, a configuration for a scheduler is specified using a human-readable n-ary tree format.

Packet processing pipeline 105 is responsible for processing packets received by network device 100 (e.g., via network ports 110-125) and determining how to forward packets. For instance, packet processing pipeline 105 may use a forwarding information base (FIB) (also referred to as a forwarding table or a MAC table) to determine how to forward packets. Additionally, when packet processing pipeline 105 determines that a particular packet is to egress out of network device 100, packet processing pipeline 105 determines an egress port (e.g., via network ports 110-125), determines a priority value associated with the particular packet, and sends the particular packet to the determined egress port for transmission out of network device 100. While FIG. 1 shows one packet processing pipeline handling the packet processing for one set of network ports, one of ordinary skill in the art will appreciate that network device 100 may include any number of packet processing pipelines that each handle packet processing for a set of network ports.

Each of the network ports 110-125 is communicatively coupled to another network device (not shown). In addition, each of the network ports 110-125 is configured to receive packets from other network devices (e.g., ingress packets) as well as transmit packets out of network device 100 (e.g., egress packets). For example, when any of the network ports 110-125 receives an ingress packet from another network device, the network port sends the ingress packet to packet processing pipeline 105 for processing. In some embodiments, each of the network ports 110-125 may include a scheduler and a set of physical queues (not shown). In some such embodiments, when any of the network ports 110-125 receives a packet from packet processing pipeline 105 for egress, the network port stores the packet in one of its physical queues based on the priority value of the packet. The scheduler of the network port controls how packets in the physical queues are transmitted out the network port.

Each of other ports 130a-n serves as an interface through which components in network device 100 can communicate. Examples of other ports 130a-n include processor ports that serve as interfaces between processor components and/or other components in network device 100, management ports that serve as interfaces between network device 100 and other devices used for managing network device 100, communication fabric ports that serve as interfaces between packet processing pipelines in network device 100, etc. In some embodiments, each of the other ports 130a-n can include a scheduler and a set of physical queues (not shown). In some such embodiments, when any of the other ports 130a-n receives a piece of data, the port stores the piece of data in one of its physical queues (e.g., based on a priority value of the piece of data). The scheduler of the port controls how pieces of data in the physical queues are transmitted out the port.

Scheduler manager 135 is configured to manage the schedulers of network ports 110-125 and other ports 130a-n. For instance, scheduler manager 135 may receive a configuration for one of the network ports 110-125 or other ports 130a-n. In response, scheduler manager 135 stores the configuration in scheduler configurations storage 140. Next, scheduler manager 135 parses the configuration. As mentioned above, in some embodiments, the configuration for a scheduler can be specified using a human-readable n-ary tree format. In some such embodiments, scheduler manager 135 parses such a configuration by traversing through the n-ary tree (e.g., a hierarchy of configuration nodes) to generate a hierarchy of scheduling nodes. Based on the parsed configuration, scheduler manager 135 then programs the scheduler of the port. For instance, scheduler manager 135 can program the scheduler by generating a set of instructions based on the hierarchy of scheduling nodes. Scheduler manager 135 executes the set of instructions to program the hierarchy of scheduling nodes in the scheduler.

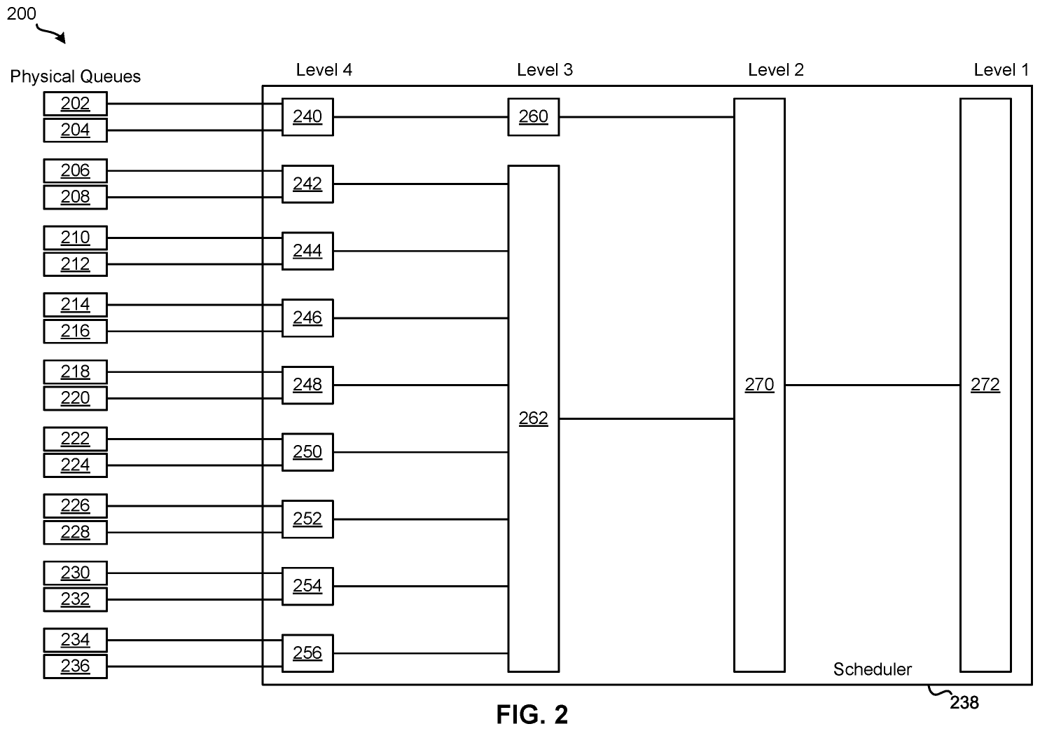

FIG. 2 illustrates a port 200 according to some embodiments. In some embodiments, port 200 can be used to implement one or more of the network ports 110-125 and the other ports 130a-n. One of ordinary skill in the art will realize that different ports in network device 100 can be configured differently using the same technique described herein. As illustrated, port 200 includes physical queues 202-236 and scheduler 238. In some embodiments, physical queues 202-236 and scheduler 238 are implemented by a set of integrated circuits (ICs). Each of the physical queues 202-236 is configured to receive pieces of data (e.g., packets) and temporarily store the pieces of data until scheduler 238 determines that they can be transmitted out of port 200. In some embodiments, each of the physical queues 202 236 is assigned a priority value and different pieces of data received by port 200 are stored in different physical queues 202 236 based on priority values associated with the pieces of data. For example, if port 200 is one of the network ports 110-125, port 200 can receive packets from packet processing pipeline 105 with priority values determined by packet processing pipeline 105. Based on the priority value of a particular packet, port 200 stores the particular packet in a corresponding physical queue that is assigned with the same priority value.

Scheduler 238 is responsible for controlling how packets in physical queues 202-236 are transmitted out of port 200. For instance, when a piece of data is to be transmitted out of port 200, scheduler 238 selects one of the physical queues 202-236 and transmits a piece of data at the beginning of the selected physical queue out through port 200. In this example, scheduler 238 selects one of the physical queues 202-236 based on a hierarchy of scheduling nodes. As shown in FIG. 2, scheduler 238 includes a hierarchy of scheduling nodes 240-272. The hierarchy of scheduling nodes 240-272 includes four different levels. The first level includes scheduling node 272. The second level in the hierarchy includes scheduling node 270 while the third level in the hierarchy includes scheduling nodes 260 and 262. The last level in the hierarch includes scheduling nodes 240-256. Each of the scheduling nodes 240-272 in the hierarchy a weight value and a type of scheduling algorithm to use. Examples of scheduling algorithms include a FIFO scheduling algorithm, a strict priority scheduling algorithm, a round robin scheduling algorithm, a weighted round robin scheduling algorithm, a weighted deficit round robin scheduling algorithm, a fair queuing scheduling algorithm, a weighted fair queuing scheduling algorithm, etc.

To select a particular physical queue 202-236 from which a piece of data is transmitted through port 200, scheduler 238 traverses through the hierarchy of scheduling nodes 240-272. In some embodiments, scheduler 238 begins at the top of the hierarchy (e.g., the root node) with scheduling node 272. Based on the scheduling algorithm specified for scheduling node 272, scheduler 238 selects a child node of scheduling node 272. For this example, scheduling node 272 has only one child node so scheduler selects scheduling node 270. Next, scheduler 238 determines the scheduling algorithm specified for scheduling node 270. Scheduler 238 then selects a child node of scheduling node 270 based on its scheduling algorithm. Here, scheduling node 270 has two child nodes so scheduler 238 selects scheduling node 260 or scheduling node 262 according to the scheduling algorithm of scheduling node 270. Scheduler 238 continues to traverse down the hierarchy of scheduling nodes in this manner until scheduler 238 uses the scheduling algorithm of a scheduling node in the fourth level of the hierarchy to select one of the physical queues 202-236. Finally, scheduler 238 transmits the piece of data at the beginning of the selected physical queue out through port 200.

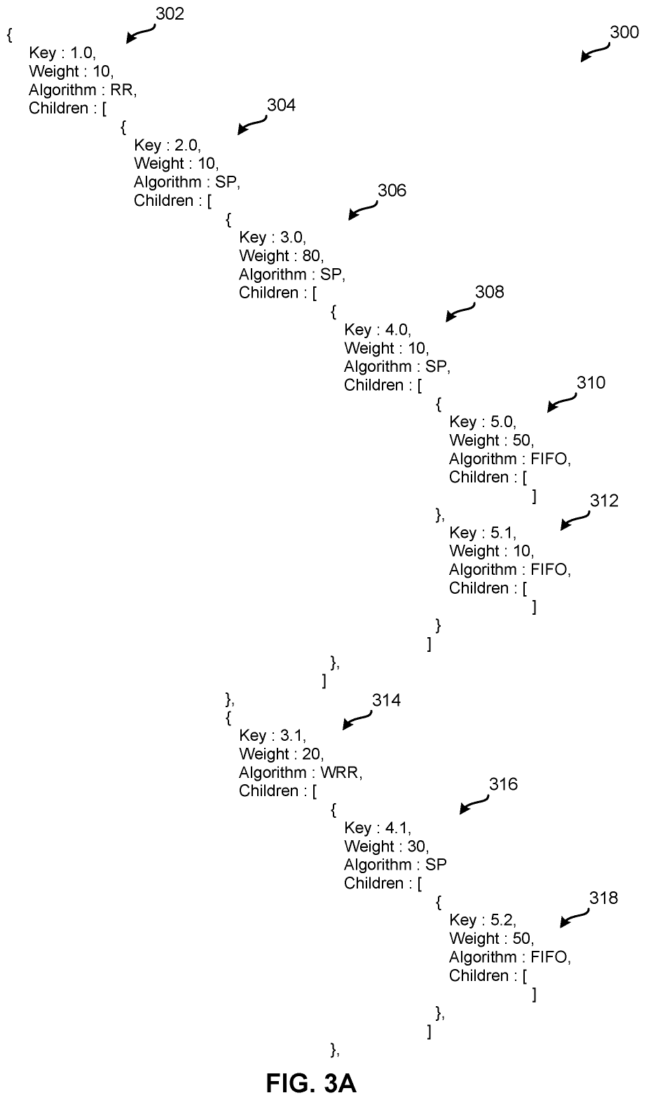

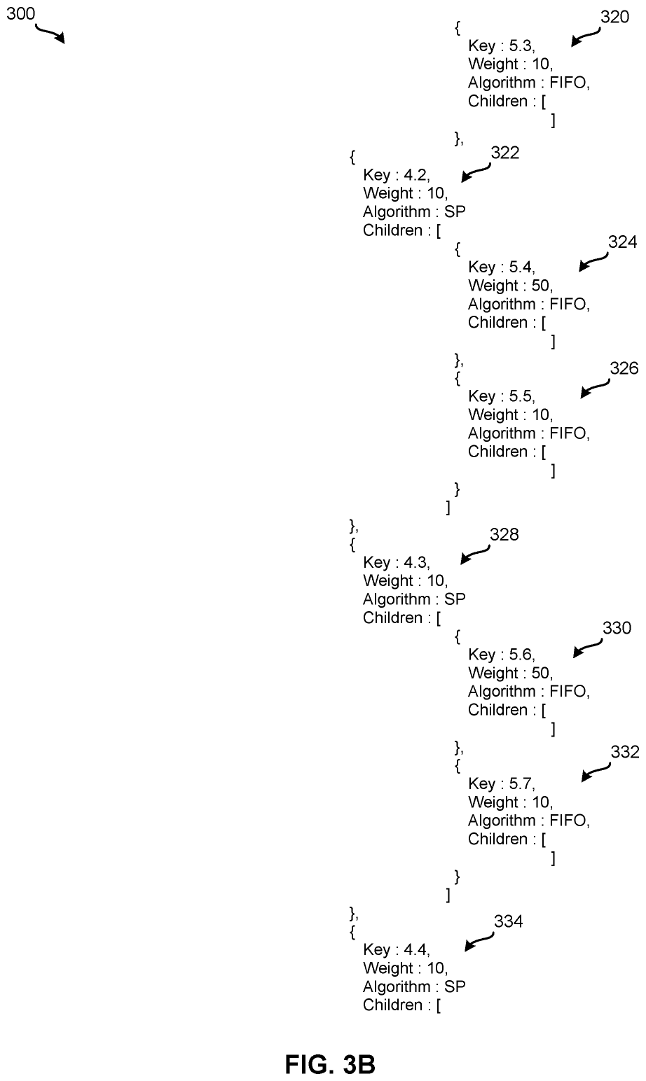

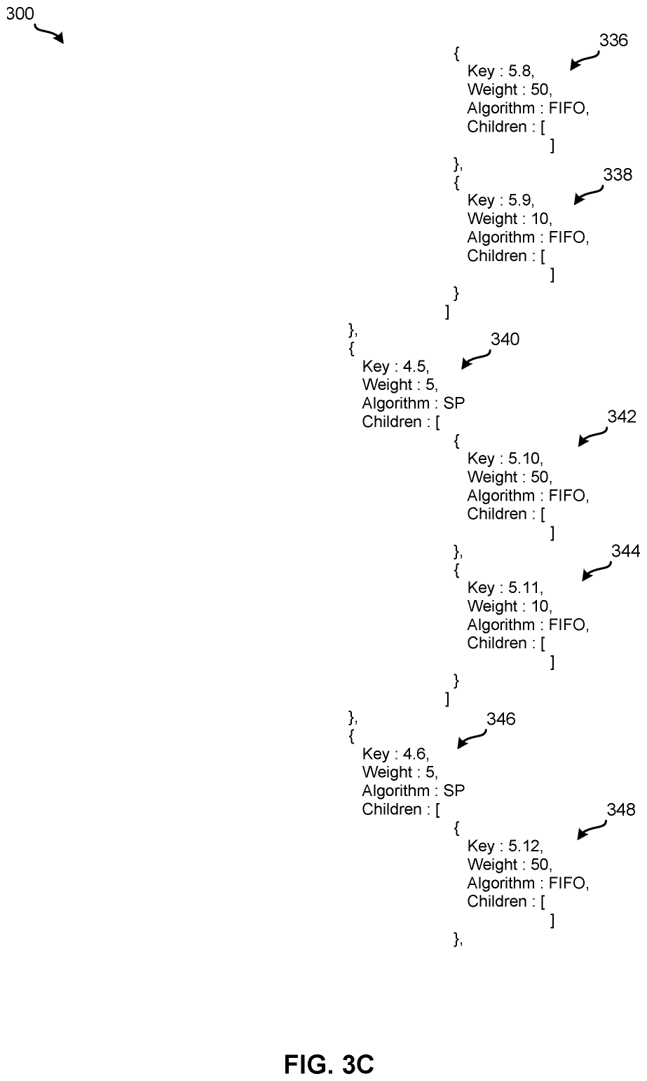

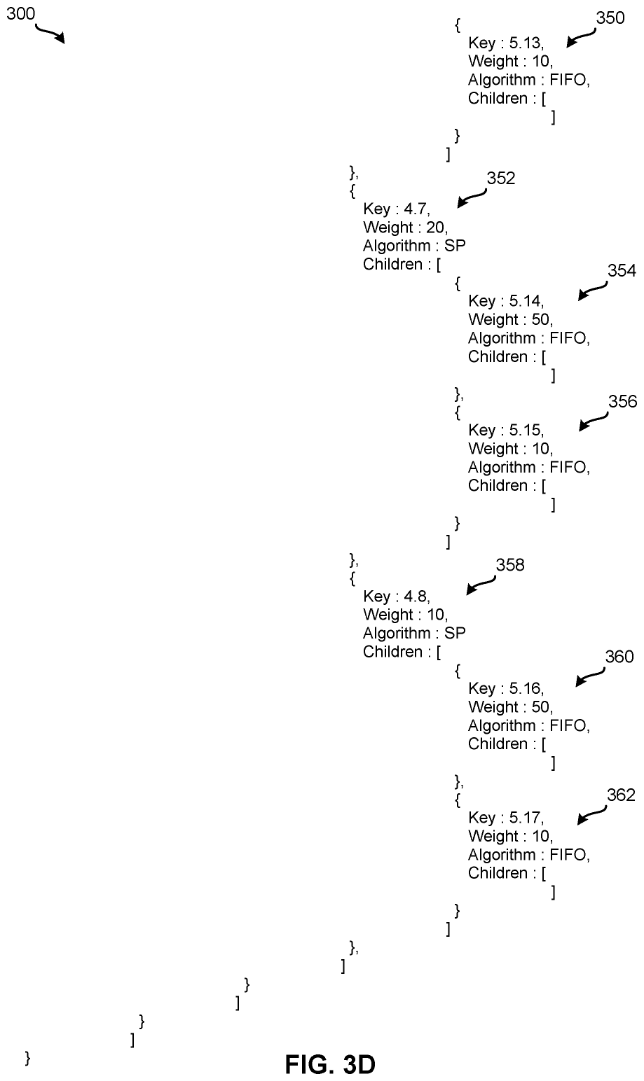

FIGS. 3A-3D illustrate a configuration 300 for a port according to some embodiments. In some embodiments, configuration 300 can be a configuration for one of the network ports 110-125 or other ports 130a-n. Scheduler manager 135 may receive (e.g., from another device used to configure network device 100) configuration 300 along with a request to program the respective network port 110-125 or other ports 130a-n. In some cases, scheduler manager 135 receives configuration 300 as a file formatted according to a JavaScript Object Notation (JSON) format. As shown in FIGS. 3A-3D, configuration 300 is specified using a human-readable n-ary tree format.

In this example, configuration 300 is used for configuring the hierarchy of scheduling nodes in scheduler 238 of port 200. Referring to FIG. 3A, configuration 300 includes configuration nodes 302-318. Configuration node 302 has an identifier attribute (“Key” in this example) for identifying the relative location (e.g., the level in the hierarchy, the position within the level, etc.) of a scheduling node in the hierarchy of scheduling nodes. The value of 1.0 for the identifier for configuration node 302 indicates that configuration node 302 represents a first node in the first level of the hierarchy of scheduling nodes. As such, configuration node 302 specifies the configuration for scheduling node 272. Additionally, configuration node 302 includes a weight attribute and an algorithm attribute for specifying a scheduling algorithm. Specifically, configuration node specifies a value of 10 for the weight attribute and a round robin scheduling algorithm for the algorithm attribute. When scheduler 238 traverses to scheduling node 272, scheduler 238 uses a round robin scheduling algorithm to select a child node of scheduling node 272. In some embodiments, a round robin scheduling algorithm selects child nodes of a scheduling node in a circular manner. If none of the physical queues associated with the selected child node have any data to transmit, scheduler 238 selects the next child node of the scheduling node in the circular order.

As depicted in FIG. 3A, configuration node 304 is a child node of configuration node 302 and specifies the configuration for scheduling node 270. In particular, configuration node 304 specifies a value of 2.0 for the identifier attribute (i.e., a first node in the second level of the hierarchy of scheduling nodes), a value of 10 for the weight attribute, and a strict priority scheduling algorithm for the algorithm attribute. When scheduler 238 traverses to scheduling node 270, scheduler 238 uses a strict priority scheduling algorithm to select a child node of scheduling node 270. In some embodiments, a strict priority scheduling algorithm selects the child node of a scheduling node with the highest weight value. If none of the physical queues associated with the selected child node have any data to transmit, scheduler 238 then selects the child node of the scheduling node with the second highest weight value and so on and so forth until a physical queue associated with the selected child node of the scheduling node has data to transmit. Here, scheduler 238 would select scheduling node 306 since it has the highest weight value between scheduling nodes 260 and 262. When none of the physical queues 202 and 204 have any data to transmit, scheduler 238 would the select scheduling node 262.

Configuration nodes 306 and 314 are child nodes of configuration node 304 and specify configurations for scheduling nodes 260 and 262, respectively. As illustrated in FIG. 3A, configuration node 306 specifies a value of 3.0 for the identifier attribute (i.e., a first node in the third level of the hierarchy of scheduling nodes), a value of 80 for the weight attribute, and a strict priority scheduling algorithm for the algorithm attribute. When scheduler 238 traverses to scheduling node 260, scheduler 238 uses a strict priority scheduling algorithm to select a child node of scheduling node 260. Configuration node 314 specifies a value of 3.1 for the identifier attribute (i.e., a second node in the third level of the hierarchy of scheduling nodes), a value of 20 for the weight attribute, and a weighted round robin scheduling algorithm for the algorithm attribute. When scheduler 238 traverses to scheduling node 262, scheduler 238 uses a weighted round robin scheduling algorithm to select a child node of scheduling node 262. In some embodiments, a weighted round robin scheduling algorithm selects a child node of a scheduling node in a circular manner with the weight values of the child nodes determining the relative number of packets transmitted in a given interval of time. For example, if twenty packets are transmitted in one second, scheduler 238 would first select scheduling node 242 six times, then select scheduling node 244 two times, then select scheduling node 246 two times, then select scheduling node 248 two times, then select scheduling node 250 one time, then select scheduling node 252 one time, then select scheduling node 254 four times, and then select scheduling node 256 two times.

Configuration node 308 is a child node of configuration node 306 and specifies the configuration for scheduling node 240. Configuration node 308 specifies a value of 4.0 for the identifier attribute (i.e., a first node in the fourth level of the hierarchy of scheduling nodes), a value of 10 for the weight attribute, and a strict priority scheduling algorithm for the algorithm attribute. When scheduler 238 traverses to scheduling node 240, scheduler 238 uses a strict priority scheduling algorithm to select a child node of scheduling node 240. Configuration nodes 310 and 312 are child nodes of configuration node 308 and specify the configurations for physical queues 202 and 204, respectively. Configuration node 310 specifies a value of 5.0 for the identifier attribute, a value of 50 for the weight attribute, and a FIFO scheduling algorithm for the algorithm attribute. Scheduler 238 selects a packet from physical queue 202 in a first in, first out fashion. Configuration node 312 specifies a value of 5.1 for the identifier attribute, a value of 20 for the weight attribute, and a FIFO scheduling algorithm for the algorithm attribute. Scheduler 238 selects a packet from physical queue 204 on a first in, first out basis.

Configuration node 316 is a child node of configuration node 314 and specifies the configuration for scheduling node 242. Configuration node 316 specifies a value of 4.1 for the identifier attribute (i.e., a second node in the fourth level of the hierarchy of scheduling nodes), a value of 30 for the weight attribute, and a strict priority scheduling algorithm for the algorithm attribute. When scheduler 238 traverses to scheduling node 242, scheduler 238 uses a strict priority scheduling algorithm to select a child node of scheduling node 242. Configuration nodes 318 and 320 are child nodes of configuration node 316 and specify the configurations for physical queues 206 and 208, respectively. Configuration node 318 specifies a value of 5.2 for the identifier attribute, a value of 50 for the weight attribute, and a FIFO scheduling algorithm for the algorithm attribute. Scheduler 238 selects a packet from physical queue 206 in a first in, first out fashion. Referring to FIG. 3B, configuration node 312 specifies a value of 5.3 for the identifier attribute, a value of 20 for the weight attribute, and a FIFO scheduling algorithm for the algorithm attribute. Scheduler 238 selects a packet from physical queue 208 on a first in, first out basis.

Configuration nodes 322, 328, 334, 340, 346, 352, and 358 are also child nodes of configuration node 314 and specifies the configurations for scheduling nodes 244-256, respectively. Each of these configurations and the configurations of its child configuration nodes (i.e., configuration nodes 324, 326, 330, 332, 336, 338, 342, 344, 348, 350, 354, 356, 360, and 362, which specify configurations for physical queues 210-236, respectively) are similar to the configuration for configuration node 316 and configurations for configuration nodes 318 and 320.

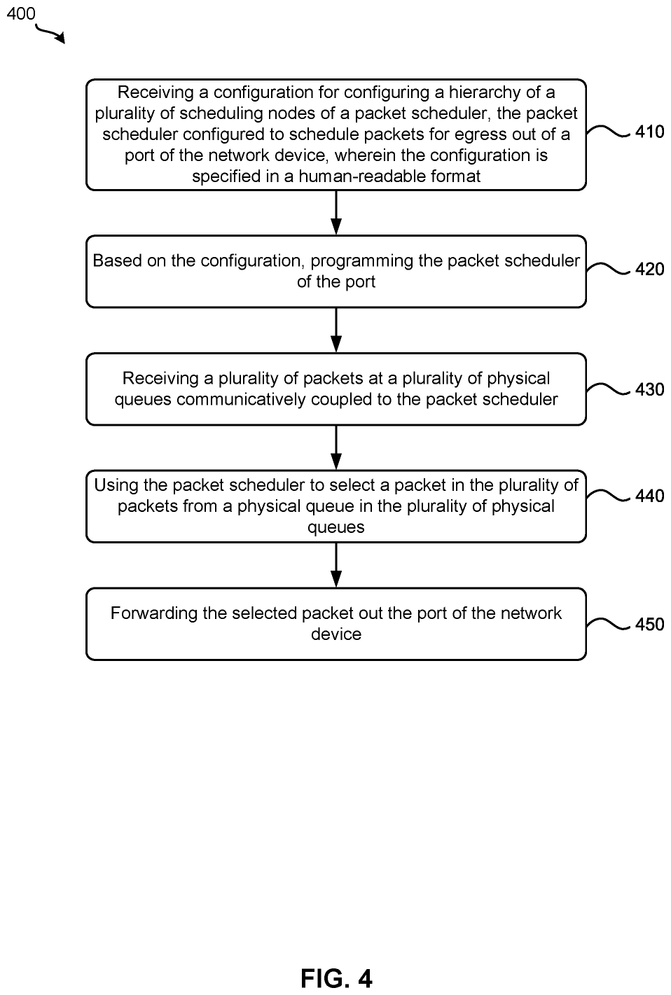

FIG. 4 illustrates a process 400 for configuring and using a scheduler of a port according to some embodiments. In some embodiments, network device 100 performs process 400. Process 400 starts by receiving, at 410, a configuration for configuring a hierarchy of a plurality of scheduling nodes of a packet scheduler. The packet scheduler is configured to schedule packets for egress out of a port of the network device. The configuration is specified in a human-readable format. Referring to FIGS. 1, 2, and 3A-3D as an example, scheduler manager 135 can receive configuration 300 (e.g., from a device used to configure network device 100), which is specified in a human-readable format, for configuring the hierarchy of scheduling nodes 240-272 in scheduler 238.

Next, based on the configuration, process 400 programs, at 420, the packet scheduler of the port. Referring to FIGS. 1, 2, and 3A-3D as an example, scheduler manager 135 may program scheduler 238 of port 200 based on configuration 300. In some embodiments, scheduler manager 135 can program scheduler 138 by parsing configuration 300 to generate a hierarchy of scheduling nodes, generating a set of instructions based on the hierarchy of scheduling nodes, and executing the set of instructions to program the hierarchy of scheduling nodes in the scheduler.

Then, process 400 receives, at 430, a plurality of packets at a plurality of physical queues communicatively coupled to the packet scheduler. Referring to FIGS. 1 and 2 as an example, network device 100 can receive several packets via network ports 110-125. Packet processing pipeline 105 can process the packets and determine that the packets are to egress out of one of the network ports 110-125, which is implemented by port 200 in this example. Upon receiving the packets, port 200 stores the packets in the appropriate physical queues 202-236, based on the priority values determined for the packets by packet processing pipeline 105.

At 440, process 400 uses the packet scheduler to select a packet in the plurality of packets from a physical queue in the plurality of physical queues. Referring to FIGS. 1 and 2 as an example, scheduler 238 may select a packet from one of the physical queues 202-236 based on the hierarchy of scheduling nodes 240-272. For example, scheduler 238 can traverse through the hierarchy of scheduling nodes 240-272 from top (i.e., starting at scheduling node 272) to bottom in the manner described above by reference to FIG. 2 until one of the physical queues 202-236 is selected.

Finally, process 400 forwards, at 450, the selected packet out the port of the network device. Referring to FIG. 2 as an example, scheduler 238 may select the packet to forward out through port 200 by selecting the packet at the beginning of the selected physical queue and transmitting the packet out through port 200.

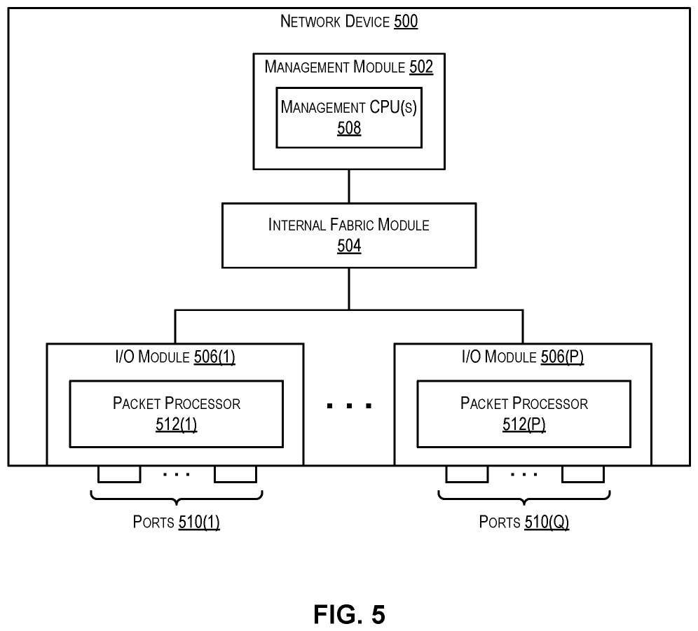

FIG. 5 illustrates the architecture of an example network device (e.g., a network switch or router) 500 that may implement the techniques of the present disclosure according to certain embodiments. For example, network device 500 may correspond to network device 100 shown in FIG. 1.

Network device 500 includes a management module 502, an internal fabric module 504, and a number of I/O modules 506(1)-(P). Management module 502 includes one or more management CPUs 508 for managing/controlling the operation of the device. Each management CPU 508 can be a general-purpose processor, such as an Intel/AMD x86 or ARM-based processor, that operates under the control of program code maintained in an associated volatile memory and/or stored in a non-transitory computer readable storage medium (not shown). In one set of embodiments, this program code can include code for implementing some or all of the techniques described in the foregoing sections.

Internal fabric module 504 and I/O modules 506(1)-(P) collectively represent the data, or forwarding, plane of network device 500. Internal fabric module 504 is configured to interconnect the various other modules of network device 500. Each I/O module 506 includes one or more input/output ports 510(1)-(Q) that are used by network device 500 to send and receive network packets. Each I/O module 506 can also include a packet processor 512, which is a hardware processing component that can make wire speed decisions on how to handle incoming or outgoing network packets.

It should be appreciated that network device 500 is illustrative and other configurations having more or fewer components than network device 500 are possible.

The following are some example embodiments of the present disclosure. In some embodiments, a non-transitory machine-readable medium storing a program executable by at least one processing unit of a network device. the program comprising sets of instructions for receiving a configuration for configuring a hierarchy of a plurality of scheduling nodes of a packet scheduler, the packet scheduler configured to schedule packets for egress out of a port of the network device, wherein the configuration is specified in a human-readable format; based on the configuration, programming the packet scheduler of the port; receiving a plurality of packets at a plurality of physical queues communicatively coupled to the packet scheduler; using the packet scheduler to select a packet in the plurality of packets from a physical queue in the plurality of physical queues; and forwarding the selected packet out the port of the network device.

In some embodiments, the configuration specifies a hierarchy of a plurality of configuration nodes. Each configuration node in the plurality of configuration nodes specifies an identifier, a weight value, and a scheduling algorithm. Programming the packet scheduler of the port comprises, based on the hierarchy of the plurality of configuration nodes, programming the packet scheduler to include the hierarchy of the plurality of scheduling nodes.

In some embodiments, the using the packet scheduler to select the packet in the plurality of packets from the physical queue in the plurality of physical queues comprises iteratively determining, by a particular scheduling node of the hierarchy of the plurality of scheduling nodes, a child node in a set of child nodes of the particular scheduling node based on the scheduling algorithm specified for the particular scheduling node and the weight values of the set of child nodes until a child node that is communicatively coupled to a particular physical queue in the plurality of physical queues is determined; and selecting a particular packet from the particular physical queue as the selected packet.

In some embodiments, the hierarchy of the plurality of configuration nodes is specified using an n-ary tree format.

In some embodiments, the using the packet scheduler to select the packet in the plurality of packets from the physical queue in the plurality of physical queues comprises traversing through the hierarchy of the plurality of scheduling nodes; based on the traversal of the hierarchy of the plurality of scheduling nodes, determining a particular physical queue in the plurality of physical queues; and selecting a particular packet from the determined physical queue as the selected packet.

In some embodiments, the present disclosure receives an ingress packet from another network device; and processes the ingress packet through a packet processing pipeline of the network device to determine a first priority value associated with the ingress packet. The ingress packet is a packet in the plurality of packets that is received at a physical queue in the plurality of physical queues. Receiving the ingress packet at the physical queue comprises determining that the first priority value associated with the ingress packet is the same as a second priority value assigned to the physical queue and storing the ingress packet in the physical queue.

In some embodiments, the port is a network port configured to send packets to and receive packets from another network device communicatively coupled to the network device.

In some embodiments, a method is executable by a network device. The method comprises receiving a human-readable file for configuring a hierarchy of a plurality of scheduling nodes of a packet scheduler that schedules packets for egress out of a port of the network device; parsing the human-readable file to determine a set of instructions; configuring the packet scheduler based on the set of instructions; receiving a plurality of packets at a plurality of physical queues communicatively coupled to the packet scheduler; using the packet scheduler to select a packet in the plurality of packets from a physical queue in the plurality of physical queues; and forwarding the selected packet out the port of the network device.

In some embodiments, a network device comprises a port; a packet scheduler configured to schedule packets for egress out of the port of the network device; a set of processing units; and a non-transitory machine-readable medium storing instructions. The instructions cause at least one processing unit in the set of processing units to receive a human-readable configuration for configuring a hierarchy of a plurality of scheduling nodes for a packet scheduler; program the packet scheduler to include the hierarchy of the plurality of scheduling nodes; receive a plurality of packets at a plurality of physical queues communicatively coupled to the packet scheduler; traverse the hierarchy of the plurality of scheduling nodes in the packet scheduler to select a packet in the plurality of packets from a physical queue in the plurality of physical queues; and forward the selected packet out the port of the network device.

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents will be evident to those skilled in the art and may be employed without departing from the spirit and scope of the disclosure as defined by the claims.

What is claimed is:

1. A non-transitory machine-readable medium storing a program executable by at least one processing unit of a network device, the program comprising sets of instructions for:
receiving a configuration for configuring a hierarchy of a plurality of scheduling nodes of a packet scheduler, the packet scheduler configured to schedule packets for egress out of a port of the network device, wherein the configuration is specified in a human-readable format;
based on the configuration, programming the packet scheduler of the port;
receiving a plurality of packets at a plurality of physical queues communicatively coupled to the packet scheduler;
using the packet scheduler to select a packet in the plurality of packets from a physical queue in the plurality of physical queues; and
forwarding the selected packet out the port of the network device.

2. The non-transitory machine-readable medium of claim 1, wherein the configuration specifies a hierarchy of a plurality of configuration nodes, wherein each configuration node in the plurality of configuration nodes specifies an identifier, a weight value, and a scheduling algorithm, wherein programming the packet scheduler of the port comprises, based on the hierarchy of the plurality of configuration nodes, programming the packet scheduler to include the hierarchy of the plurality of scheduling nodes.

3. The non-transitory machine-readable medium of claim 2, wherein using the packet scheduler to select the packet in the plurality of packets from the physical queue in the plurality of physical queues comprises:
iteratively determining, by a particular scheduling node of the hierarchy of the plurality of scheduling nodes, a child node in a set of child nodes of the particular scheduling node based on the scheduling algorithm specified for the particular scheduling node and the weight values of the set of child nodes until a child node that is communicatively coupled to a particular physical queue in the plurality of physical queues is determined; and
selecting a particular packet from the particular physical queue as the selected packet.

4. The non-transitory machine-readable medium of claim 2, wherein the hierarchy of the plurality of configuration nodes is specified using an n-ary tree format.

5. The non-transitory machine-readable medium of claim 1, wherein using the packet scheduler to select the packet in the plurality of packets from the physical queue in the plurality of physical queues comprises:
traversing through the hierarchy of the plurality of scheduling nodes;
based on the traversal of the hierarchy of the plurality of scheduling nodes, determining a particular physical queue in the plurality of physical queues; and
selecting a particular packet from the determined physical queue as the selected packet.

6. The non-transitory machine-readable medium of claim 1, wherein the program further comprises a set of instructions for:
receiving an ingress packet from another network device; and
processing the ingress packet through a packet processing pipeline of the network device to determine a first priority value associated with the ingress packet;
wherein the ingress packet is a packet in the plurality of packets that is received at a physical queue in the plurality of physical queues,
wherein receiving the ingress packet at the physical queue comprises determining that the first priority value associated with the ingress packet is the same as a second priority value assigned to the physical queue and storing the ingress packet in the physical queue.

7. The non-transitory machine-readable medium of claim 1, wherein the port is a network port configured to send packets to and receive packets from another network device communicatively coupled to the network device.

8. A method executable by a network device, the method comprising:
receiving a human-readable file for configuring a hierarchy of a plurality of scheduling nodes of a packet scheduler that schedules packets for egress out of a port of the network device;
parsing the human-readable file to determine a set of instructions;
configuring the packet scheduler based on the set of instructions;
receiving a plurality of packets at a plurality of physical queues communicatively coupled to the packet scheduler;
using the packet scheduler to select a packet in the plurality of packets from a physical queue in the plurality of physical queues; and
forwarding the selected packet out the port of the network device.

9. The method of claim 8, wherein the human-readable file specifies a hierarchy of a plurality of configuration nodes, wherein each configuration node in the plurality of configuration nodes specifies an identifier, a weight value, and a scheduling algorithm, wherein configuring the packet scheduler of the port comprises, based on the hierarchy of the plurality of configuration nodes, programming the packet scheduler to include the hierarchy of the plurality of scheduling nodes.

10. The method of claim 9, wherein using the packet scheduler to select the packet in the plurality of packets from the physical queue in the plurality of physical queues comprises:
iteratively determining, by a particular scheduling node of the hierarchy of the plurality of scheduling nodes, a child node in a set of child nodes of the particular scheduling node based on the scheduling algorithm specified for the particular scheduling node and the weight values of the set of child nodes until a child node that is communicatively coupled to a particular physical queue in the plurality of physical queues is determined; and
selecting a particular packet from the particular physical queue as the selected packet.

11. The method of claim 9, wherein the hierarchy of the plurality of configuration nodes is specified using an n-ary tree format.

12. The method of claim 8, wherein using the packet scheduler to select the packet in the plurality of packets from the physical queue in the plurality of physical queues comprises:
traversing through the hierarchy of the plurality of scheduling nodes;
based on the traversal of the hierarchy of the plurality of scheduling nodes, determining a particular physical queue in the plurality of physical queues; and
selecting a particular packet from the determined physical queue as the selected packet.

13. The method of claim 8 further comprising:
receiving an ingress packet from another network device; and
processing the ingress packet through a packet processing pipeline of the network device to determine a first priority value associated with the ingress packet;
wherein the ingress packet is a packet in the plurality of packets that is received at a physical queue in the plurality of physical queues,
wherein receiving the ingress packet at the physical queue comprises determining that the first priority value associated with the ingress packet is the same as a second priority value assigned to the physical queue and storing the ingress packet in the physical queue.

14. The method of claim 8, wherein the port is a network port configured to send packets to and receive packets from another network device communicatively coupled to the network device.

15. A network device comprising:
a port;
a packet scheduler configured to schedule packets for egress out of the port of the network device;
a set of processing units; and
a non-transitory machine-readable medium storing instructions that when executed by at least one processing unit in the set of processing units cause the at least one processing unit to:
receive a human-readable configuration for configuring a hierarchy of a plurality of scheduling nodes for a packet scheduler;
program the packet scheduler to include the hierarchy of the plurality of scheduling nodes;
receive a plurality of packets at a plurality of physical queues communicatively coupled to the packet scheduler;
traverse the hierarchy of the plurality of scheduling nodes in the packet scheduler to select a packet in the plurality of packets from a physical queue in the plurality of physical queues; and
forward the selected packet out the port of the network device.

16. The system of claim 15, wherein the human-readable configuration specifies a hierarchy of a plurality of configuration nodes, wherein each configuration node in the plurality of configuration nodes specifies an identifier, a weight value, and a scheduling algorithm, wherein programming the packet scheduler of the port comprises, based on the hierarchy of the plurality of configuration nodes, programming the packet scheduler to include the hierarchy of the plurality of scheduling nodes.

17. The system of claim 16, wherein using the packet scheduler to select the packet in the plurality of packets from the physical queue in the plurality of physical queues comprises:
iteratively determining, by a particular scheduling node of the hierarchy of the plurality of scheduling nodes, a child node in a set of child nodes of the particular scheduling node based on the scheduling algorithm specified for the particular scheduling node and the weight values of the set of child nodes until a child node that is communicatively coupled to a particular physical queue in the plurality of physical queues is determined; and
selecting a particular packet from the particular physical queue as the selected packet.

18. The system of claim 16, wherein the hierarchy of the plurality of configuration nodes is specified using an n-ary tree format.

19. The system of claim 15, wherein using the packet scheduler to select the packet in the plurality of packets from the physical queue in the plurality of physical queues comprises:
traversing through the hierarchy of the plurality of scheduling nodes;
based on the traversal of the hierarchy of the plurality of scheduling nodes, determining a particular physical queue in the plurality of physical queues; and
selecting a particular packet from the determined physical queue as the selected packet.

20. The system of claim 15, wherein the instructions further cause the at least one processing unit to:
receive an ingress packet from another network device; and
process the ingress packet through a packet processing pipeline of the network device to determine a first priority value associated with the ingress packet;
wherein the ingress packet is a packet in the plurality of packets that is received at a physical queue in the plurality of physical queues,
wherein receiving the ingress packet at the physical queue comprises determining that the first priority value associated with the ingress packet is the same as a second priority value assigned to the physical queue and storing the ingress packet in the physical queue.
